(19) United States
(12) Patent Application Publication
(10) Pub. No.: US 2013/0061715 A1
(43) Pub. Date: Mar. 14, 2013

(54) PEDAL OF EXERCISE EQUIPMENT

(71) Applicant: Yu Chul Kim, Siheung-si (KR)

(72) Inventor: Yu Chul Kim, Siheung-si (KR)

(21) Appl. No.: 13/700,713

(22) PCT Filed: May 24, 2011
(86) PCT No.: PCT/KR2011/003800

§ 371 Date: Nov. 28, 2012

(30) Foreign Application Priority Data
May 31, 2010 (KR) 10-2010-0051107

(51) Int. Cl. B62M 3/08

(52) U.S. Cl. CPC B62M 3/08
USPC 74/594.7

(57) ABSTRACT

A pedal for exercise equipment concentrates foot effort applied for driving and realizes stable stepping of pedal bodies with soles. The pedal includes a pedal body and a connection shaft connected to a crank rod of pedal exercise equipment. A pair of first and second inclination control plates are respectively mounted at the front and rear surfaces of the pedal body, and hinge-connected to the pedal body at the crank rod connection side thereof. A pair of fixing screws fix the second and first inclination control plates to the pedal body, wherein the positioning angle of the sole is set to be larger than 0° for effective driving power transmission to the crank rod, and deviation of the sole from the pedal body is prevented under the free control of the sole positioning angle according to the body type of a user.

### FIELD OF THE INVENTION

The present invention relates to a pedal of various pedal exercise equipment such as bicycles, wherein it is possible to concentrate foot effort applied for driving and to realize stable stepping of pedal bodies with soles.

### DESCRIPTION OF THE RELATED ART

Recently, there have been suggested various kinds of pedal exercise equipment to which the present invention relates. There are, for example, bicycles for traveling roads by rotating wheels using pedals, or bicycle type exercise equipment and lower body correcting equipment for carrying out leg exercise on the spot.

FIG. 1 shows a perspective view of a prior art pedal of pedal exercise equipment in the assembled state and FIG. 2 shows a perspective view of the prior art pedal of pedal exercise equipment of FIG. 1.

In pedal exercise equipment as shown in FIG. 1, a pedal 100′ is usually connected to a driving sprocket 300′ via a crank rod 200′ and the driving sprocket 300′ is connected to a driven sprocket, which is connected to wheels via chains.

The pedal 100′ of pedal exercise equipment, as shown in FIG. 2, includes a connection shaft 110′ which is connected to the crank rod 200′, and a rectangular pedal body 120′ which a sole contacts, wherein the body 120′ is kept horizontally with respect to the ground surface when the connection shaft 110′ is connected to the crank rod 200′.

### SUMMARY OF THE INVENTION

### Problems that the Invention is to Solve

Therefore, the positioning angle of the sole of a user, which contacts the front surface of the pedal body 120′, is kept in horizontal, so that the sole of the user may be slipped in the right or left direction of the pedal body 120′ when the crank rod is rotated by pressing the pedal body 120′. If the slippage in the direction opposite the crank rod connection side is severe, the sole of the user may deviate from the pedal body 120′.

Meanwhile, the pedal 100′ of pedal exercise equipment promotes effective pedal exercise, wherein large driving force may be obtained from small force as the foot effort is concentrated more on the crank rod connection side in the stepping portion of the pedal body 120′.

However, in the prior art pedal 100′ of pedal exercise equipment as shown in FIG. 1 and FIG. 2, the pedal body 120′ is formed as a single part and all the top surface and the bottom surface of the pedal body 120′ are formed horizontally, so that a foot is pushed towards a side opposite the crank rod connection side of the pedal body 120′ as if the foot is slipped away.

Therefore, it becomes difficult to concentrate the foot effort on the crank rod connection side of the pedal body 120′, and the sole becomes gradually slipped away towards the side opposite the crank rod connection side of the pedal body 120′ to be likely to deviate from the pedal body 120′.

In addition, in the case of a Mountain Bike MTB, for example, the road surface is particularly bumpy so that the sole is likely to be separated from the contact with the pedal due to impacts. At this time, if a user tries to step on the pedal with his foot, the foot is gradually slipped outwards, deviating from the pedal. Therefore, the normal riding of the bike becomes impossible instantly and safety accidents or the like may be induced.

Therefore, in order to make the foot effort concentrated on a position which is closest to the crank rod connection side of the pedal body 120′ while positioning the sole on the pedal body 120′ stably, it is preferable to set the positioning angle of the sole to be larger than 0° by inclining the front surface and the rear surface of the pedal body 120′ in such a manner that the crank rod connection side is low and the side opposite the crank rod connection side is high.

Therefore, the present invention has been accomplished in order to resolve the above-mentioned disadvantages and any other problems, and an object of the present invention is to provide a pedal of pedal exercise equipment, wherein it is possible to set the positioning angle of a sole to be larger than 0° so that the sole may be positioned on the pedal in such a manner that a crank rod connection side is low and the side opposite the crank rod connection side is high. Therefore, it is possible to concentrate the foot effort to the crank rod connection side of the pedal body for promoting effective pedal exercise while positioning the pedal body with the sole stably in order to prevent the sole from deviating from the pedal body.

The present invention has another object to provide a pedal of pedal exercise equipment, wherein it is possible to freely control the positioning angle of a sole in a predetermined range in consideration of the body type or the like of a user.

### Means for Solving the Problem

In order to accomplish the above objects, there is provided a pedal of pedal exercise equipment, which includes: a connection shaft connected to a crank rod of the pedal exercise equipment; a pedal body rotatively connected to the connection shaft; a pair of first inclination control plates respectively mounted at the front surface and the rear surface of the pedal body, and hinge-connected to the pedal body at the crank rod connection side thereof so as to be protruded towards the upper end or the lower end of the pedal body at the side opposite the crank rod connection side; a pair of second inclination control plates respectively mounted at the front surface and the rear surface of the pedal body, and hinge-connected to the pedal body at the crank rod connection side thereof together with the first inclination control plates so as to be protruded towards the lower end or the upper end of the pedal body at the side opposite the crank rod connection side; and a pair of fixing screws coupled with the pedal body by penetrating the second inclination control plates and the first inclination control plates so as to fix the second inclination control plates and the first inclination control plates.

In the pedal of pedal exercise equipment according to the present invention, the pedal body has hinge screw coupling holes respectively formed in the front surface and the rear surface at the crank rod connection side, a plurality of control screw coupling holes respectively formed in the centers of the front surface and the rear surface at the same interval in the horizontal direction, and fixing screw coupling holes respectively formed in the front surface and the rear surface at the side opposite the crank rod connection side; the first inclination control plates have hinge screw passing holes formed at the crank rod connection side, a plurality of control holes formed in the centers at the same interval in the inclination direction that the crank rod connection side is high and the side opposite the crank rod connection side is low, and fixing screw passing holes formed in the shape of elongated holes at the side opposite the crank rod connection side; and the second inclination control plates have hinge screw passing holes formed at the crank rod connection side, a plurality of control holes formed in the centers at the same interval in the inclination direction that the crank rod connection side is low and the side opposite the crank rod connection side is high, and fixing screw passing holes formed in the shape of elongated holes at the side opposite the crank rod connection side.

According to the present invention, the pedal of pedal exercise equipment further includes finishing plates respectively mounted at the front portion and the rear portion of the pedal body, wherein the finishing plates have hinge screw passing holes formed at the crank rod connection side, a plurality of control screw passing holes respectively formed in the centers at the same interval in the horizontal direction, and fixing screw passing holes respectively formed at the side opposite the crank rod connection side.

In the pedal of pedal exercise equipment according to the present invention, the pedal body has the hinge screw coupling holes respectively formed in the front surface and the rear surface at the crank rod connection side, a plurality of control pin connecting holes formed in the shape of elongated holes respectively in the centers of the front surface and the rear surface in the horizontal direction, and fixing screw coupling holes respectively formed in the front surface and the rear surface at the side opposite the crank rod connection side; the first inclination control plates have the hinge screw passing holes formed at the crank rod connection side, control holes formed the shape of stepped elongation holes with a plurality of steps in the centers in the inclination direction that the crank rod connection side is high and the side opposite the crank rod connection side is low, and the fixing screw passing holes formed in the shape of elongated holes at the side opposite the crank rod connection side; the second inclination control plates have the hinge screw passing holes formed at the crank rod connection side, control holes formed in the shape of stepped elongation holes with a plurality of steps in the centers in the inclination direction that the crank rod connection side is low and the side opposite the crank rod connection side is high, and fixing screw passing holes formed in the shape of elongated holes at the side opposite the crank rod connection side; and the control holes of the respective inclination control plates may be formed as elongated holes in the arc shape.

In the pedal of pedal exercise equipment according to the present invention, a plurality of sliding-preventing indent grooves may be formed at the upper ends and the lower ends of the first inclination control plates and the upper ends and the lower ends of the second inclination control plates.

### Effects of the Invention

According to the pedal of pedal exercise equipment of the present invention, a pair of first inclination control plates and a pair of second inclination control plates are respectively protruded with inclinations from the upper end and the lower end of the pedal body so that a sole positioning angle may be set to be larger than 0°. Therefore, a foot may be positioned towards the crank rod connection side of the pedal body, so that large driving force may be obtained with small foot effort.

In addition, it is also possible to prevent the sole from deviating out of the pedal body.

Furthermore, according to the pedal of pedal exercise equipment of the present invention, the sole positioning angle may be freely controlled in a predetermined range according to the body type of a user.

### BRIEF DESCRIPTION OF THE DRAWINGS

The objects, features and advantages of the present invention will be more clearly understood from the preferred embodiments in the following detailed description in conjunction with the accompanying drawings, in which:

FIG. 1 is a perspective view of a prior art pedal of pedal exercise equipment, wherein the pedal is in the mounted state.

FIG. 2 is a perspective view of the pedal of pedal exercise equipment.

FIG. 3 is a perspective view of a bottom surface of a pedal of pedal exercise equipment according to a first embodiment of the present invention.

FIG. 4 is a disassembled perspective view of a control screw according to the first embodiment.

FIG. 5 is a disassembled perspective view of the first embodiment.

FIG. 6a to FIG. 6c are front views of the first embodiment.

FIG. 7 is a perspective view of a second embodiment of the present invention.

FIG. 8 is a disassembled perspective view of the second embodiment.

FIG. 9a to FIG. 9c are front views of the second embodiment.

FIG. 10 is a perspective view of a third embodiment of the present invention.

FIG. 11 is a disassembled perspective view of the third embodiment.

FIG. 12a to FIG. 12c are front views of the third embodiment.

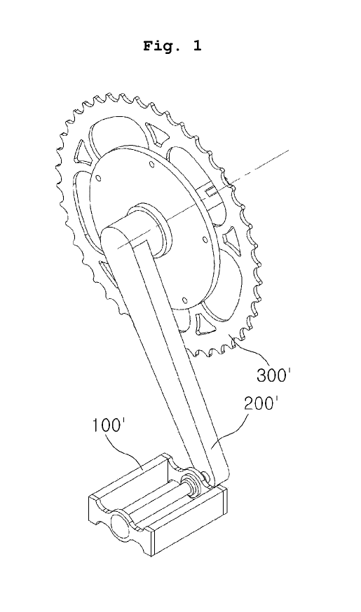

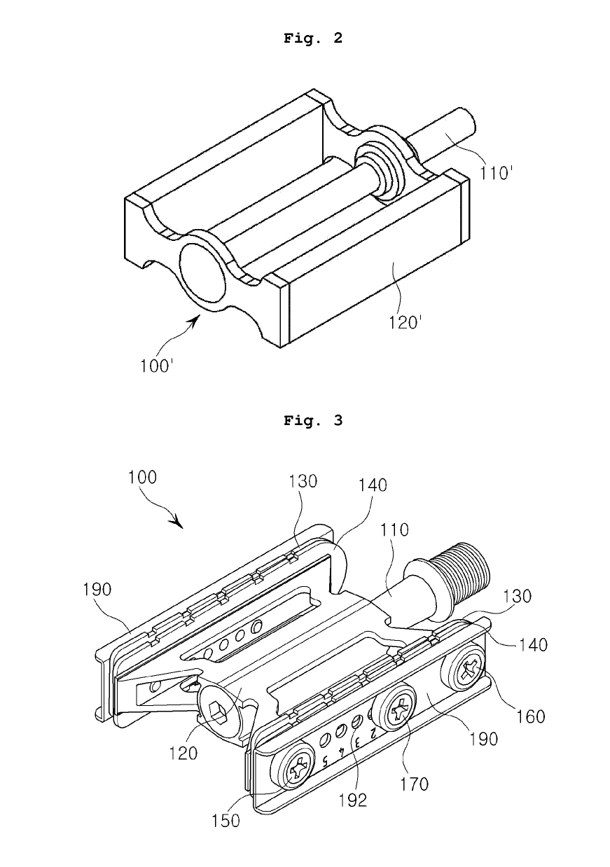

### DETAILED DESCRIPTION OF THE PREFERRED EMBODIMENT

Now, a pedal of pedal exercise equipment according to the present invention in order to accomplish the above objects will be described in more detail with reference to the accompanying drawings.

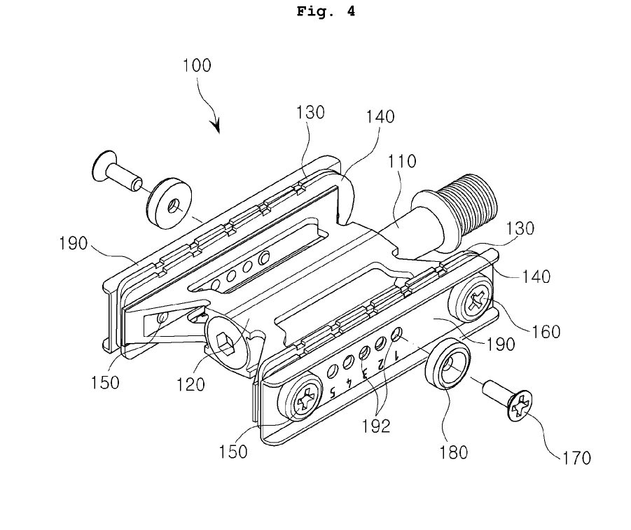

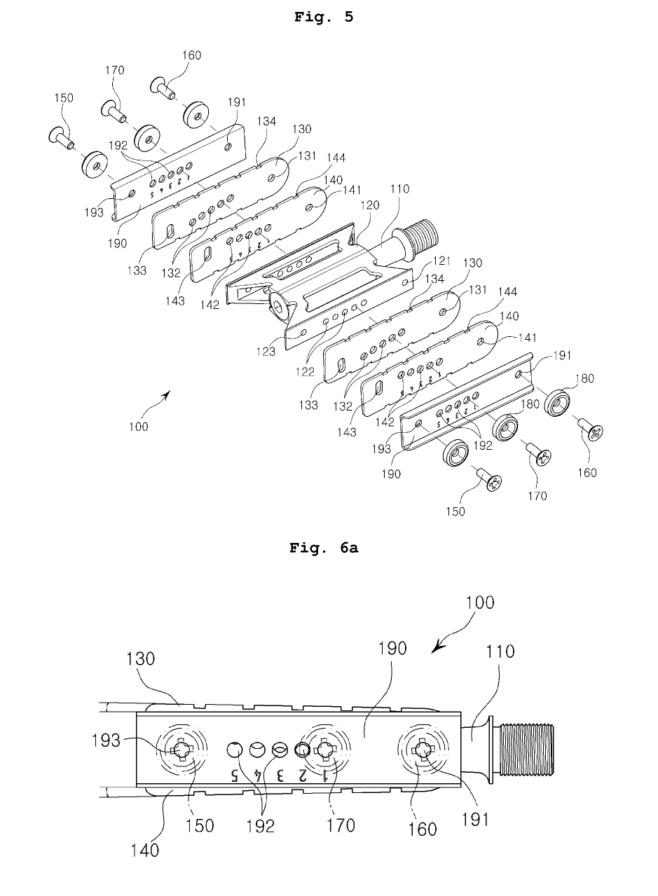

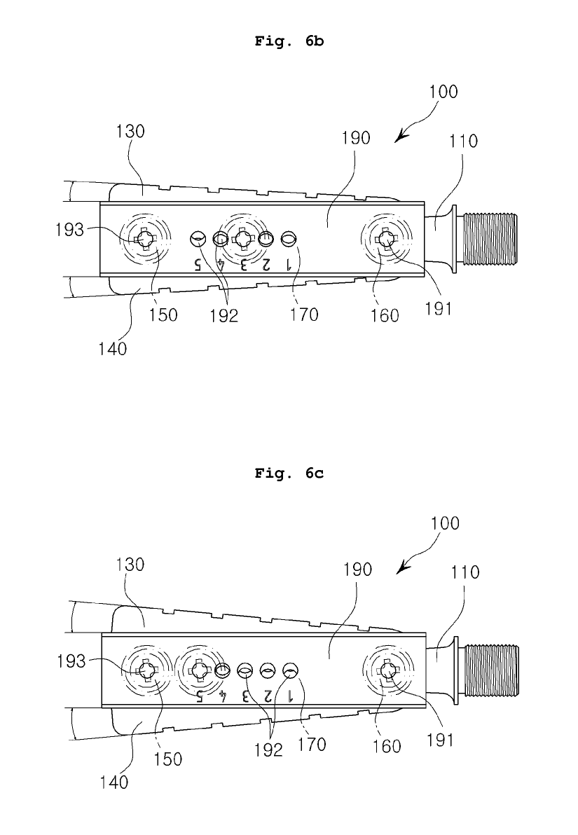

FIG. 3 is a perspective view of a bottom surface of a pedal of pedal exercise equipment according to a first embodiment of the present invention, FIG. 4 is a disassembled perspective view of a control screw according to the first embodiment, FIG. 5 is a disassembled perspective view of the first embodiment, and FIG. 6a to FIG. 6c are front views of the first embodiment.

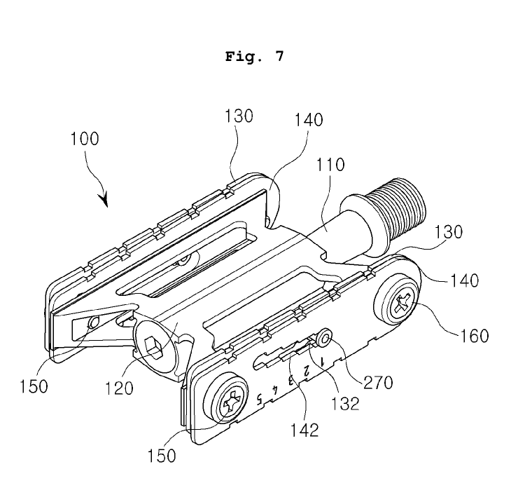

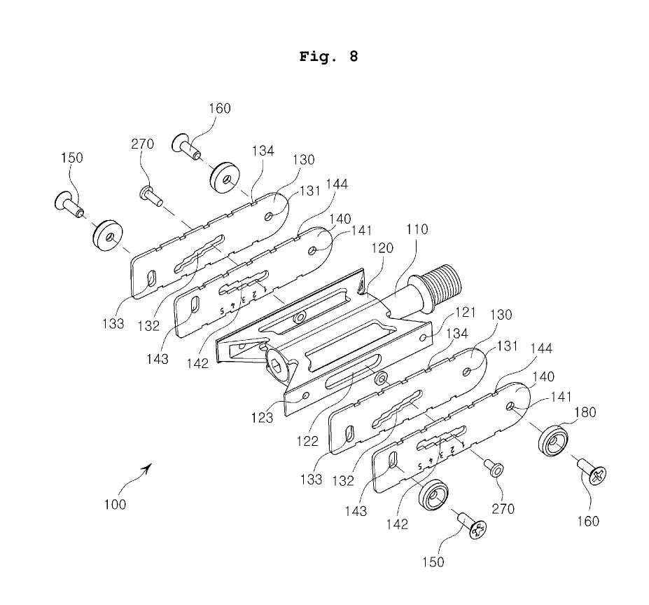

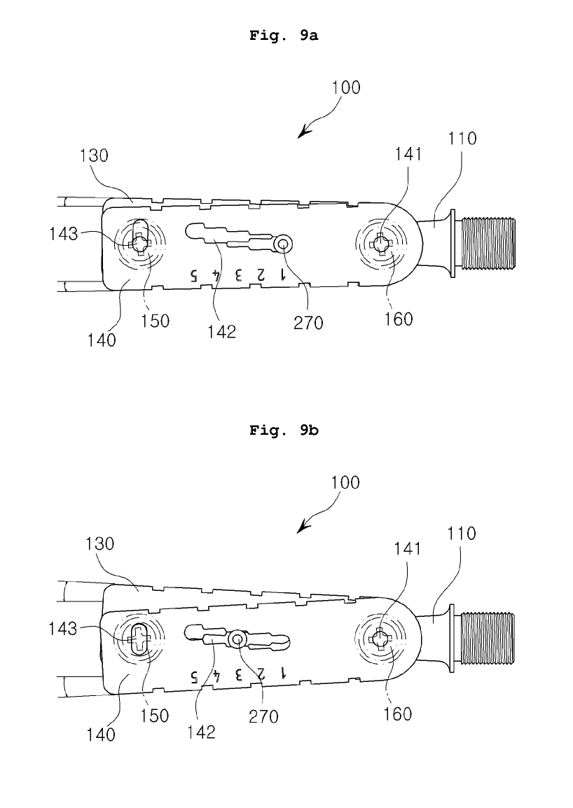

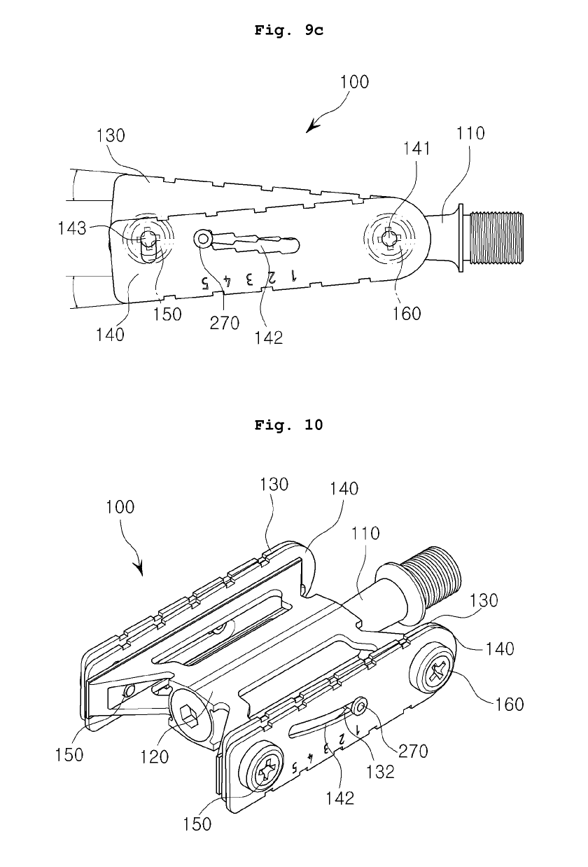

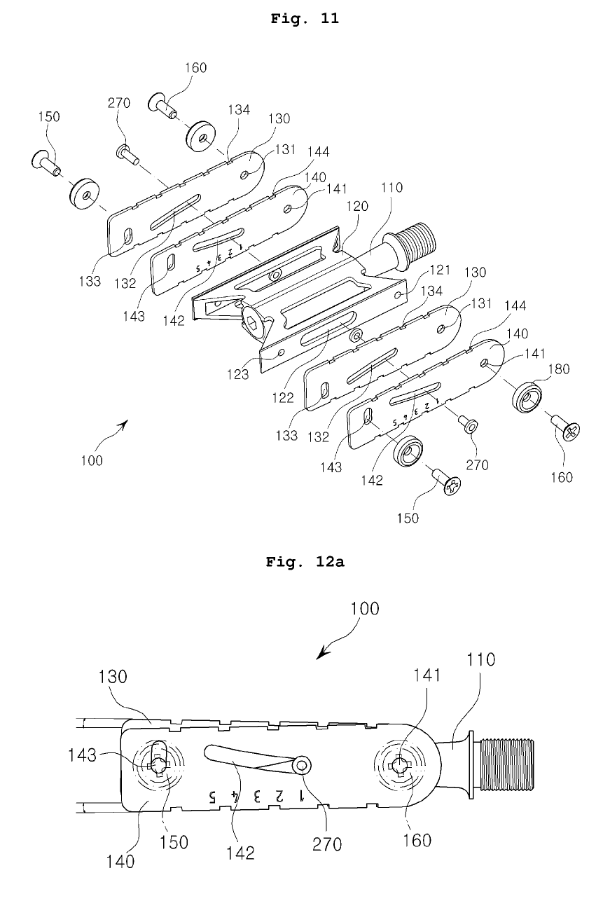

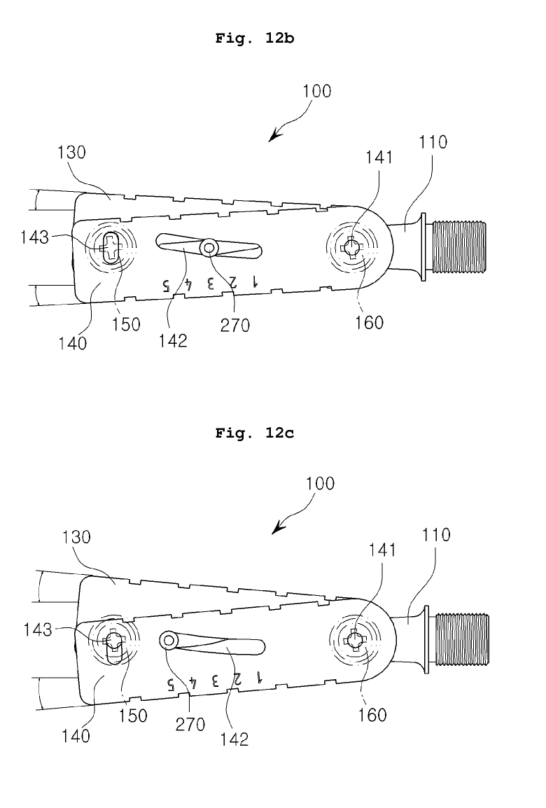

FIG. 7 is a perspective view of a second embodiment of the present invention, FIG. 8 is a disassembled perspective view of the second embodiment, FIG. 9a to FIG. 9c are front views of the second embodiment, FIG. 10 is a perspective view of a third embodiment of the present invention, FIG. 11 is a disassembled perspective view of the third embodiment, and FIG. 12a to FIG. 12c are front views of the third embodiment.

Referring to FIG. 3 to FIG. 12c, a pedal 100 of pedal exercise equipment according to the present invention includes: a connection shaft 110 connected to a crank rod of pedal exercise equipment; a pedal body 120 rotatively connected to the connection shaft 110; a pair of first inclination control plates 130 respectively mounted at the front surface and the rear surface of the pedal body 120, and hinge-connected to the pedal body 120 at the crank rod connection side thereof so as to be protruded towards the upper end or the lower end of the pedal body 120 at the side opposite the crank rod connection side; a pair of second inclination control plates 140 respectively mounted at the front surface and the rear surface of the pedal body 120, and hinge-connected to the pedal body 120 at the crank rod connection side thereof together with the first inclination control plates 130 so as to be protruded towards the lower end or the upper end of the pedal body 120 at the side opposite the crank rod connection side; and a pair of fixing screws 150 coupled with the pedal body 120 by penetrating the second inclination control plates 140 and the first inclination control plates 130 so as to fix the second inclination control plates 140 and the first inclination control plates 130.

In the pedal 100 of pedal exercise equipment according to the present invention, a pair of the first inclination control plate 130 are rotated so that the side opposite the crank rod connection side is protruded towards the lower end or the upper end of the pedal body 120. Simultaneously, a pair of the second inclination control plate 140 are rotated so that the side opposite the crank rod connection side is protruded towards the upper end or the lower end of the pedal body 120, that is, in the direction opposite to the protrusion direction of the first inclination control plate 130. Therefore, the positioning angle of the sole may be set to be larger than 0°, promoting effective pedal exercise.

In addition, via the control screw 170 which penetrates the second inclination control plate 140 and the first inclination control plate 130 and is coupled with the pedal body 120, the second inclination control plate 140 and the first inclination control plate 130 are fixed so that a set sole positioning angle may be stably kept.

In the pedal 100 of pedal exercise equipment according to the present invention, it is possible to freely control the sole positioning angle, that is, inclination angles of the respective inclination control plates 130 and 140 in a predetermined range by increasing or decreasing protrusion degrees of a pair of the first inclination control plate 130 and a pair of the second inclination control plate 140 towards the side opposite the crank rod connection side.

FIG. 3 to FIG. 6c show the pedal 100 of pedal exercise equipment according to the first embodiment of the present invention.

Referring to FIG. 3 to FIG. 6c, in the pedal 100 of pedal exercise equipment according to the first embodiment of the present invention, the pedal body 120 has hinge screw coupling holes 121 respectively formed in the front surface and the rear surface thereof at the crank rod connection side, a plurality of control screw coupling holes 122 respectively formed in the centers of the front surface and the rear surface at the same interval in the horizontal direction, and fixing screw coupling holes 123 respectively formed in the front surface and the rear surface at the side opposite the crank rod connection side.

In the pedal 100 of pedal exercise equipment according to the first embodiment, the first inclination control plates 130 have hinge screw passing holes 131 formed at the crank rod connection side, a plurality of control holes 132 formed in the centers at the same interval in the inclination direction that the crank rod connection side is high and the side opposite the crank rod connection side is low, and fixing screw passing holes 133 formed in the shape of elongated holes at the side opposite the crank rod connection side.

In the pedal 100 of pedal exercise equipment according to the first embodiment, the second inclination control plates 140 have hinge screw passing holes 141 formed at the crank rod connection side, a plurality of control holes 142 formed in the centers at the same interval in the inclination direction that the crank rod connection side is low and the side opposite the crank rod connection side is high, and fixing screw passing holes 143 formed in the shape of elongated holes at the side opposite the crank rod connection side.

Meanwhile, the pedal 100 of pedal exercise equipment according to the first embodiment includes finishing plates 190 respectively mounted at both sides of the pedal body 120 for preventing damages to the first inclination control plates 130 and the second inclination control plates 140.

In the pedal 100 of pedal exercise equipment according to the first embodiment, the finishing plates 190 have hinge screw passing holes 191 formed at the crank rod connection side, a plurality of control screw passing holes 192 respectively formed in the centers at the same interval in the horizontal direction, and fixing screw passing holes 193 respectively formed at the side opposite the crank rod connection side.

In addition, the finishing plates 190 are provided with outward folding parts 194 at the upper end and the lower end thereof.

In the pedal 100 of pedal exercise equipment according to the first embodiment, the pedal body 120 is provided with the first inclination plate 130, the second inclination plate 140, and finishing plate 190 in sequence in close contact on the front surface thereof, and a hinge screw 160 passes through the hinge screw passing hole 191 of the finishing plate 190, the hinge screw passing hole 141 of the second inclination control plate 140, and the hinge screw passing hole 131 of the first inclination control plate 130 so as to be coupled in the hinge screw coupling holes 121 of the front surface of the pedal body 120.

The control screw 170 passes through anyone of the control screw passing holes 192 of the finishing plate 190, anyone of a plurality of the control holes 142 of the second inclination control plate 140, and anyone of a plurality of the control holes 132 of the first inclination control plate 130 so as to be coupled in the control screw coupling hole 122 of the front surface of the pedal body 120.

The fixing screw 150 passes through the fixing screw passing hole 193 of the finishing plate 190, the fixing screw passing hole 143 of the second inclination control plate 140, and the fixing screw passing hole 133 of the first inclination control plate 130 so as to be coupled in the fixing screw coupling hole 123 of the front surface of the pedal body 120.

In the pedal 100 of pedal exercise equipment according to the first embodiment, the pedal body 120 is provided with the second inclination plate 140, the first inclination plate 130, and the finishing plate 190 in sequence in close contact on the rear surface thereof, and the hinge screw 160 passes through the hinge screw passing hole 191 of the finishing plate 190, the hinge screw passing hole 131 of the first inclination control plate 130, and the hinge screw passing hole 141 of the second inclination control plate 140 so as to be coupled in the hinge screw coupling holes 121 of the rear surface of the pedal body 120.

In addition, the control screw 170 passes through anyone of the control screw passing holes 192 of the finishing plate 190, anyone of a plurality of the control holes 132 of the first inclination control plate 130, and anyone of a plurality of the control holes 142 of the second inclination control plate 140 so as to be coupled in the control screw coupling hole 122 of the rear surface of the pedal body 120.

The fixing screw 150 passes through the fixing screw passing hole 193 of the finishing plate 190, the fixing screw passing hole 133 of the first inclination control plate 130, and fixing screw passing hole 123 of the second inclination control plate 140 so as to be coupled in the fixing screw coupling hole 123 of the rear surface of the pedal body 120.

In the pedal 100 of pedal exercise equipment according to the first embodiment, contact bushings 180 are mounted between the hinge screws 160 and the finishing plates 190, between the control screws 170 and the finishing plates 140, and between the fixing screws 150 and the finishing plates 190 of the front surface and the rear surface of the pedal body 120.

In the meantime, in the pedal 100 of pedal exercise equipment according to the first embodiment, it is possible to simply control a sole positioning angle by changing the coupling positions of the control screws 170.

In other words, in order to control the contact angle of a sole and the pedal 100, the control screws 170 are completely released, the fixing screws 150 are loosely released, and after that, the coupling positions of the control screws 170 are moved towards the side opposite the crank rod connection side. Then, the side opposite the crank rod connection side of each of the first inclination control plates 130 is lifted and simultaneously the side opposite the crank rod connection side of each of the second inclination control plates 140 is lowered, so that the sole positioning angle becomes increased.

In addition, if the coupling positions of the control screws 170 are moved towards the crank rod connection side, then the side opposite the crank rod connection side of each of the first inclination control plates 130 is lowered and simultaneously the side opposite the crank rod connection side of each of the second inclination control plates 140 is lifted, so that the sole positioning angle becomes decreased.

In the pedal 100 of pedal exercise equipment according to the first embodiment, as shown in FIG. 6a, if the control screw 170 passes through a first one of the control screw passing holes 192 at the crank rod connection side of the finishing plate 190, first ones of the control holes 132 and 142 at the at the crank rod connection side of the respectively inclination control plates 130 and 140, and a first one of the control screw coupling holes 192 at the crank rod connection side of the pedal body 120, then the sole positioning angle may be controlled to be minimum via the respective first inclination control plates 130 and the respective second inclination control plates 140.

As shown in FIG. 6C, if the control screw 170 passes through a first one of the control screw passing holes 192 at the side opposite the crank rod connection side of the finishing plate 190, first ones of the control holes 132 and 142 at the at the side opposite the crank rod connection side of the respective inclination control plates 130 and 140, and a first one of the control screw coupling holes 192 at the side opposite the crank rod connection side of the pedal body 120, then the side opposite the crank rod connection side of the respective first inclination control plates 130 is lifted maximally and simultaneously the side opposite the crank rod connection side of the respective second inclination control plates 140 is lowered maximally, so that the sole positioning angle may be controlled to be maximum.

In the pedal 100 of pedal exercise equipment according to the first embodiment, if the coupling position of the control screw 170 is changed and the loosely released fixing screw 150 is fastened again after controlling the sole positioning angle, then the respective inclination control plates 130 and 140 may be stably fixed to the pedal body 120.

FIG. 7 to FIG. 9c show a pedal 100 of pedal exercise equipment according to the second embodiment of the present invention.

Referring to FIG. 7 to FIG. 9c, in the pedal 100 of pedal exercise equipment according to a second embodiment of the present invention, the pedal body 120 has the hinge screw coupling holes 121 respectively formed in the front surface and the rear surface at the crank rod connection side, control pin connecting holes 122 formed in the shape of elongated holes respectively in the centers of the front surface and the rear surface in the horizontal direction, and fixing screw coupling holes 123 respectively formed in the front surface and the rear surface at the side opposite the crank rod connection side.

In the pedal 100 of pedal exercise equipment according to the second embodiment of the present invention, the first inclination control plates 130 have the hinge screw passing holes 131 formed at the crank rod connection side, control holes 132 formed the shape of stepped elongation holes with a plurality of steps in the centers in the inclination direction that the crank rod connection side is high and the side opposite the crank rod connection side is low, and the fixing screw passing holes 133 formed in the shape of elongated holes at the side opposite the crank rod connection side.

In the pedal 100 of pedal exercise equipment according to the second embodiment of the present invention, the second inclination control plates 140 have hinge screw passing holes 141 formed at the crank rod connection side, control holes 142 formed the shape of stepped elongation holes with a plurality of steps in the centers in the inclination direction that the crank rod connection side is low and the side opposite the crank rod connection side is high, and fixing screw passing holes 143 formed in the shape of elongated holes at the side opposite the crank rod connection side.

In the pedal 100 of pedal exercise equipment according to the second embodiment of the present invention, the pedal body 120 is provided with the first inclination plate 130 and the second inclination plate 140 in sequence in close contact on the front surface thereof, and the hinge screw 160 passes through the hinge screw passing hole 141 of the second inclination control plate 140 and the hinge screw passing hole 131 of the first inclination control plate 130 so as to be coupled in the hinge screw coupling holes 121 of the front surface of the pedal body 120.

A control pin 270 in the rivet shape passes through the control hole 142 of the second inclination control plate 140, the control hole 132 of the first inclination control plate 130, and the control screw coupling hole 122 of the front surface of the pedal body 120. The fixing screw 150 passes through the fixing screw passing hole 143 of the second inclination control plate 140 and the fixing screw passing hole 133 of the first inclination control plate 130 so as to coupled in the fixing screw coupling hole 123 of the front surface of the pedal body 120.

In the pedal 100 of pedal exercise equipment according to the second embodiment of the present invention, the pedal body 120 is provided with the second inclination plate 140 and the first inclination plate 130 in sequence in close contact on the rear surface thereof, and the hinge screw 160 passes through the hinge screw passing hole 131 of the first inclination control plate 130 and the hinge screw passing hole 141 of the second inclination control plate 140 so as to be coupled in the hinge screw coupling holes 121 of the rear surface of the pedal body 120.

The control pin 270 in the rivet shape passes through the control hole 132 of the first inclination control plate 130, the control hole 142 of the second inclination control plate 140, and the control screw connection hole 122 of the rear surface of the pedal body 120. The fixing screw 150 passes through the fixing screw passing hole 133 of the first inclination control plate 130 and the fixing screw passing hole 123 of the second inclination control plate 140 so as to coupled in the fixing screw coupling hole 123 of the rear surface of the pedal body 120.

In the pedal 100 of pedal exercise equipment according to the second embodiment of the present invention, the contact bushings 180 are mounted between the hinge screw 160 and the second inclination control plate 140 and between the fixing screw 150 and the second inclination control plate 140 on the front surface of the pedal body 120, while the contact bushings 180 are mounted between the hinge screw 160 and the first inclination control plate 130 and between the fixing screw 150 and the first inclination control plate 130 on the rear surface of the pedal body 120.

In the pedal 100 of pedal exercise equipment according to the second embodiment of the present invention, if the coupling position of the control pin 270 is changed by moving the control pin 270 right and left in the state that the fixing screw 150 is loosely released, then it is possible to simply control the sole positioning angle.

That is, in order to control the contact angle of a sole and the pedal 100, the fixing screws 150 are loosely released, and after that, the coupling position of the control pins 270 are moved towards the side opposite the crank rod connection side. Then, the side opposite the crank rod connection side of each of the first inclination control plates 130 is lifted and simultaneously the side opposite the crank rod connection side of each of the second inclination control plates 140 is lowered, so that the sole positioning angle becomes increased.

In addition, if the coupling position of the control pin 270 are moved towards the crank rod connection side, then the side opposite the crank rod connection side of each of the first inclination control plates 130 is lowered and simultaneously the side opposite the crank rod connection side of each of the second inclination control plates 140 is lifted, so that the sole positioning angle becomes decreased.

In the pedal 100 of pedal exercise equipment according to the second embodiment of the present invention, as shown in FIG. 9a, if the control pins 270 are moved to the control holes 132 and 142 of the respective inclination control plates 130 and 140 to be moved maximally towards the crank rod connection side of the respective inclination control plates 130 and 140, then the sole positioning angle may be controlled to be minimum via the respective first inclination control plates 130 and the respective second inclination control plates 140. As shown in FIG. 9c, if the control pins 270 are moved to the control holes 132 and 142 of the respective inclination control plates 130 and 140 to be moved maximally towards the side opposite the crank rod connection side of the respective inclination control plates 130 and 140, then the side opposite the crank rod connection side of the respective first inclination control plates 130 is lifted maximally and simultaneously the side opposite the crank rod connection side of the respective second inclination control plates 140 is lowered maximally, so that the sole positioning angle may be controlled to be maximum.

In the pedal 100 of pedal exercise equipment according to the second embodiment, if the coupling position of the control pin 270 is changed and the loosely released fixing screw 150 is fastened again after controlling the sole positioning angle, then the respective inclination control plates 130 and 140 may be stably fixed to the pedal body 120.

FIG. 10 to FIG. 12c show a pedal 100 of pedal exercise equipment according to a third embodiment of the present invention.

Referring to FIG. 10 to FIG. 12c, the pedal 100 of pedal exercise equipment according to the third embodiment of the present invention includes the control holes 132 and 142 of the respective inclination control plates 130 140 as shown in the pedal 100 of pedal exercise equipment according to the above second embodiment, wherein even though the control holes 132 and 142 are formed as the elongated holes in the stepped shape in the second embodiment, they are formed as elongated holes in the arc shape in the third embodiment.

In the pedal 100 of pedal exercise equipment according to the third embodiment of the present invention, it is also possible to simply control the sole positioning angle by changing the coupling positions of the control pins 270 by moving the control pins 270 right and left in the state that the fixing screws 150 are loosely released in the same manner as the case of the pedal 100 of pedal exercise equipment according to the second embodiment.

As shown in FIG. 12a, if the control pins 270 are moved to the control holes 132 and 142 of the respective inclination control plates 130 and 140 to be moved maximally towards the crank rod connection side of the respective inclination control plates 130 and 140, then the sole positioning angle may be controlled to be minimum via the respective first inclination control plates 130 and the respective second inclination control plates 140.

As shown in FIG. 12c, if the control pins 270 are moved to the control holes 132 and 142 of the respective inclination control plates 130 and 140 to be moved maximally towards the side opposite the crank rod connection side of the respective inclination control plates 130 and 140, then the side opposite the crank rod connection side of the respective first inclination control plates 130 is lifted maximally and simultaneously the side opposite the crank rod connection side of the respective second inclination control plates 140 is lowered maximally, so that the sole positioning angle may be controlled to be maximum.

In the meantime, in the pedals of pedal exercise equipment 100 according to the first embodiment to the third embodiment, a plurality of sliding-preventing indent grooves 134 and 144 are formed at the same interval at the upper ends and the lower ends of the first inclination control plates 130 and at the upper ends and the lower ends of the second inclination control plates 140.

The pedal of the present invention as described hereinabove may be employed in the bicycle type exercise equipments and the lower body correcting equipments for carrying out leg exercise in addition to the bicycles for traveling roads or the mountain bikes.

Although the present invention has been described in detail by reference to the forgoing embodiments and accompanying drawings, the present invention is not limited thereto and it is apparent to those skilled in the art that various changes and modifications of the present invention maybe made without departing the spirit and scope of the invention.

Description of Reference Numerals and Signs

| | |
|---|---|
| 100: pedal of pedal exercise equipment | |
| 110: connection shaft | |
| 120: pedal body | |
| 121: hinge screw coupling hole | |
| 122: control screw coupling hole | |
| 123: fixing screw coupling hole | |
| 130: first inclination control plate | |
| 131: hinge screw passing hole | |
| 132: control screw passing hole | |
| 133: fixing screw passing hole | |
| 134: sliding-preventing indent groove | |
| 140: second inclination control plate | |
| 141: hinge screw passing hole | |
| 142: control screw passing hole | |
| 143: fixing screw passing hole | |
| 144: sliding-preventing indent groove | |
| 150: fixing screw | 160: hinge screw |
| 170: control screw | 180: contact bushing |
| 190: finishing plate | |
| 191: hinge screw passing hole | |
| 192: control screw passing hole | |
| 193: fixing screw passing hole | |
| 194: outward folding part | 270: control pin |

1. A pedal comprising:
a connection shaft connected to a crank rod of pedal exercise equipment;
a pedal body rotatively connected to the connection shaft;
a pair of first inclination control plates respectively mounted at the front surface and the rear surface of the pedal body, and hinge-connected to the pedal body at the crank rod connection side thereof so as to be protruded towards the upper end or the lower end of the pedal body at the side opposite the crank rod connection side;
a pair of second inclination control plates respectively mounted at the front surface and the rear surface of the pedal body, and hinge-connected to the pedal body at the crank rod connection side thereof together with the first inclination control plates so as to be protruded towards the lower end or the upper end of the pedal body at the side opposite the crank rod connection side; and
a pair of fixing screws coupled with the pedal body by penetrating the second inclination control plates and the first inclination control plates so as to fix the second inclination control plates and the first inclination control plates.

2. A pedal according to claim 1,
wherein the pedal body has hinge screw coupling holes respectively formed in the front surface and the rear surface at the crank rod connection side, a plurality of control screw coupling holes respectively formed in the centers of the front surface and the rear surface at the same interval in the horizontal direction, and fixing screw coupling holes respectively formed in the front surface and the rear surface at the side opposite the crank rod connection side;
the first inclination control plates have hinge screw passing holes formed at the crank rod connection side, a plurality of control holes formed in the centers at the same interval in the inclination direction that the crank rod connection side is high and the side opposite the crank rod connection side is low, and fixing screw passing holes formed in the shape of an elongated hole at the side opposite the crank rod connection side; and
the second inclination control plates have hinge screw passing holes formed at the crank rod connection side, a plurality of control holes formed in the centers at the same interval in the inclination direction that the crank rod connection side is low and the side opposite the crank rod connection side is high, and fixing screw passing holes formed in the shape of an elongated hole at the side opposite the crank rod connection side.

3. A pedal according to claim 2, further comprising finishing plates respectively mounted at the front portion and the rear portion of the pedal body;
wherein the finishing plates have hinge screw passing holes formed at the crank rod connection side, a plurality of control screw passing holes respectively formed in the centers at the same interval in the horizontal direction, and fixing screw passing holes respectively formed at the side opposite the crank rod connection side.

4. A pedal according to claim 1,
wherein the pedal body has the hinge screw coupling holes respectively formed in the front surface and the rear surface at the crank rod connection side, a plurality of control pin connecting holes formed in the shape of elongated holes respectively in the centers of the front surface and the rear surface in the horizontal direction, and fixing screw coupling holes respectively formed in the front surface and the rear surface at the side opposite the crank rod connection side;
the first inclination control plates have the hinge screw passing holes formed at the crank rod connection side, control holes formed the shape of stepped elongation holes with a plurality of steps in the centers in the inclination direction that the crank rod connection side is high and the side opposite the crank rod connection side is low, and the fixing screw passing holes formed in the shape of an elongated hole at the side opposite the crank rod connection side; and
the second inclination control plates have the hinge screw passing holes formed at the crank rod connection side, control holes formed the shape of stepped elongation holes with a plurality of steps in the centers in the inclination direction that the crank rod connection side is low and the side opposite the crank rod connection side is high, and fixing screw passing holes formed in the shape of an elongated hole at the side opposite the crank rod connection side.

5. A pedal according to claim 4, wherein the control holes an of the respective inclination control plates and are formed as elongated holes in the arc shape.

6. A pedal according to claim 1, wherein a plurality of sliding-preventing indent grooves and are formed at the upper ends and the lower ends of the first inclination control plates and the upper ends and the lower ends of the second inclination control plates.
